(19) United States
(12) Patent Application Publication
(10) Pub. No.: US 2010/0166308 A1
(43) Pub. Date: Jul. 1, 2010

(54) PICTURE SIGNAL PROCESSING DEVICE, PICTURE SIGNAL PROCESSING METHOD, AND PICTURE DISPLAY DEVICE

(76) Inventor: Yuichi Honda, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/640,784

(22) Filed: Dec. 17, 2009

(30) Foreign Application Priority Data
Dec. 25, 2008 (JP) 2008-330853

(51) Int. Cl. G06K 9/00

(52) U.S. Cl. 382/168

(57) ABSTRACT

According to one embodiment, a picture processing device comprises a horizontal contour correction module configured to correct a horizontal contour of a picture by adding a contour correction signal to an input picture signal, a histogram acquisition module configured to acquire a luminance histogram of the picture, and a computation control module configured to acquire a control amount G for each luminance level of a horizontal contour correction processing from the luminance histogram, acquire a control amount G for each luminance level of horizontal contour correction processing from the luminance histogram, acquire a control amount G(b) for each luminance level of a non-linear processing from the luminance histogram, and acquire a control amount (G(a)) which can acquire the control amount G when the control amount G(b) is given to supply to the horizontal contour correction module and makes the horizontal contour correction module execute the horizontal contour correction processing.

### CROSS-REFERENCE TO RELATED APPLICATIONS

This application is based upon and claims the benefit of priority from Japanese Patent Application No. 2008-330853, filed Dec. 25, 2008, the entire contents of which are incorporated herein by reference.

### BACKGROUND

1. Field

One embodiment of the invention relates to a picture signal processing device and a picture processing method which perform horizontal contour correction for an input picture signal; and relates to a picture display device employing the device and the method.

2. Description of the Related Art

In general, in a picture processing device, a horizontal contour correction circuit correcting a horizontal contour for an input picture signal is installed. However, since excessive contour accentuation causes adverse effect of giving glaring feeling to a viewer, the improvement of a shortage of the contour accentuation to a small part of a contour change by avoiding luminance contour accentuation of a large part of the contour change is proposed (See, e.g., Jpn. Pat. Appln. KOKAI Publication No. 11-243496).

Meanwhile, in the foregoing picture processing device, non-linear processing is performed after performing processing for the input luminance signal by reason of securing a dynamic range in a display system. However, depending on an input signal, a minute amplitude component is compressed by the non-linear processing, and adverse effect such as deterioration in detail may be caused. A component producing moderate amplitude may be extremely extended and may be excessively accentuated by means of an excessive contour correction component, and adverse effect such as glaring feeling may be generated.

As mentioned above, in the horizontal contour correction circuit in a conventional picture processing device, there is a problem such that a case where the correction circuit is used together with the non-linear processing poses a picture scene of which the luminance is compressed becomes a short of detail expression, and a picture scene of which the luminance is extended increases a noise and gives the glaring feeling due to the excessive contour correction component.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram depicting an embodiment of a picture display device with a picture processing device of the invention employed;

FIG. 2 is an exemplary flowchart depicting a control procedure of a horizontal contour correction amount in a processor of the embodiment;

FIG. 3 is an exemplary input/output characteristics view depicting a non-linear characteristics example in a non-linear processing circuit of the embodiment;

FIG. 4 is an exemplary input/output characteristics view depicting a case of a differential gain of non-linear characteristics is 1 in he embodiment;

FIG. 5 is an exemplary input/output characteristics view depicting an influence on a contour correction component in a case where the differential gain is larger than 1 in the embodiment;

FIG. 6 is an exemplary input/output characteristics view depicting an influence on a contour correction component in a case where the differential gain is smaller than 1 in the embodiment;

FIG. 7 is an exemplary input/output characteristics view depicting an adjustment example of a contour correction amplitude width which is larger than the differential gain 1 in the embodiment;

FIG. 8 is an exemplary input/output characteristics view depicting an adjustment example of a contour correction amplitude width in a case where the differential gain is smaller than 1 in the embodiment; and

FIGS. 9A and 9B are exemplary views depicting characteristics examples for explaining relationships between horizontal contour correction control amounts and non-linear characteristics in the embodiments, respectively.

### DETAILED DESCRIPTION

Various embodiments according to the invention will be described hereinafter with reference to the accompanying drawings. In general, according to one embodiment of the invention, there is provided a picture processing device using horizontal contour correction processing together with non-linear processing, comprising: a horizontal contour correction module configured to extract a high-frequency area component of a picture signal, selectively multiply an arbitrary accentuation amount to the high-frequency area component to generate a contour correction signal, and correct a horizontal contour of a picture by adding the contour correction signal to the picture signal; a histogram acquisition module configured to measure the number of pixels of each luminance level of the picture signal to acquire a luminance histogram; and a computation control module configured to compute a control amount of control instructing the accentuation amount on the basis of the luminance histogram, wherein the computation control module obtains a first control amount for each luminance level of the horizontal contour correction from the luminance histogram, obtains a second control amount for each luminance level of the non-linear processing from the luminance histogram, and obtains a third control amount capable of obtaining the first control amount when the second control amount is given to supply the third control amount to the horizontal contour correction module.

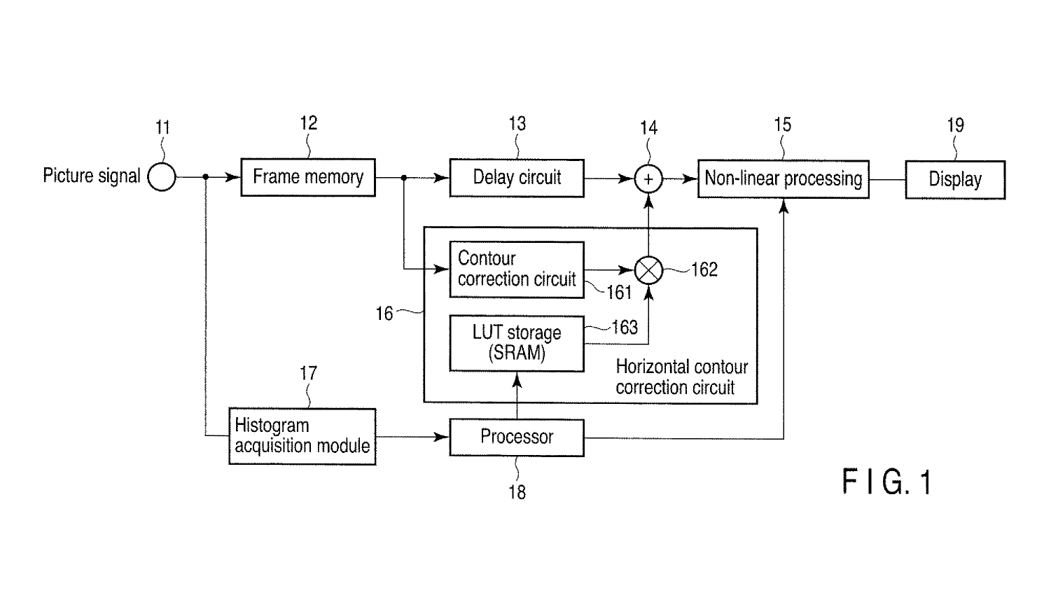

FIG. 1 shows a block diagram illustrating an embodiment of a picture display device including a picture processing device with the invention employed therein. In FIG. 1, a picture signal (luminance signal) input from a terminal 11 is delayed by one frame by means of a frame memory 12, further delayed by a time required for contour correction by means of a delay circuit 13, and then added a contour correction component given below by means of an adder 14 to be supplied to a non-linear processing circuit 15.

An output picture signal from the frame memory 12 is supplied to a contour correction circuit 161 of a horizontal contour correction circuit 16 of the invention. The correction circuit 161 extracts an arbitrary high-frequency area component from the input picture signal, and the extraction result is supplied to a multiplier 162. Meanwhile, accentuation amount tables of a plurality of steps are stored in a look up table (LUT) storage module 163 consisting of a static random access memory (SRAM), and an accentuation amount instructed from a processor 18 mentioned below is read to be output. The accentuation amount read from the LUT storage module 163 is multiplied by the high-frequency area obtained by the correction circuit 161 to be supplied, as the contour correction component, to the adder 14.

Meanwhile, the picture signal input from the terminal 11 is input to a histogram acquisition module 17. The histogram acquisition module 17 sequentially takes in picture signals of one frame secured in the frame memory 12, measures the number of pixels of each luminance level for each frame to acquire luminance histogram information. The histogram information is supplied to the processor 18. The processor 18 obtains an accentuation amount of a horizontal contour on the basis of the histogram information, and instructs the LUT storage module 163 so as to read the corresponding-value. The processor 18 calculates non-linear characteristics of gamma correction, etc., from the histogram information, and supplies its characteristics data to a nonlinear processing circuit 15 to make the non-linear processing execute. The picture signal obtained in this way is supplied to a display 19 to be displayed.

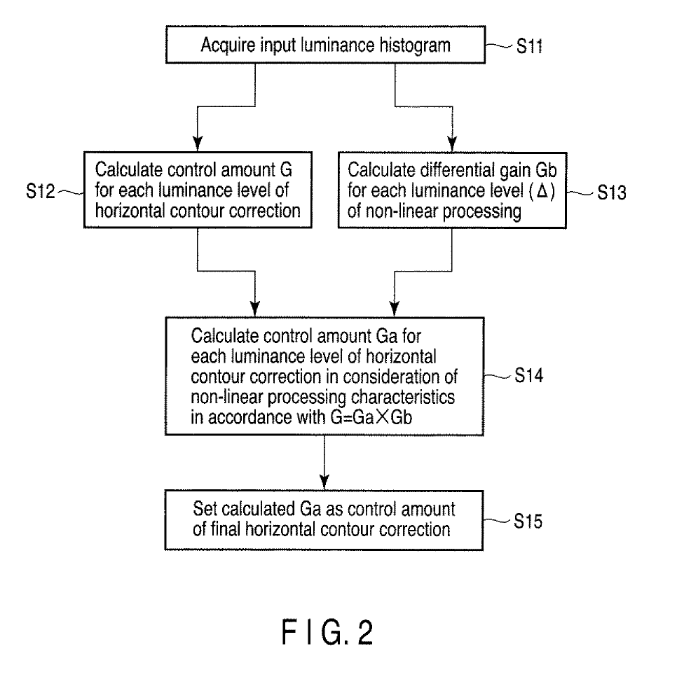

In the configuration mentioned above, the control of the horizontal contour correction amount in the processor 18 will be described with reference to the flowchart shown in FIG. 2.

First, when a luminance histogram of one frame is supplied from the histogram acquisition module 17 (Step S11), the control of the horizontal contour correction amount calculates a control amount G for each luminance level of the horizontal contour correction (Step S12), and also calculates a differential gain Gb for each luminance level (Δ) of non-linear processing (Step S13).

In succession, the control calculates a control amount Ga of the horizontal control correction in the consideration of the non-linear processing characteristics for each luminance level in accordance with the following relationship (Step S14)

G=Ga×Gb

Finally, the control instructs the control amount Ga calculated in the above way to the LUT storage module 163 and reads the corresponding-accentuation amount to output it (Step S15).

The process of controlling the high-frequency accentuation amount in the processor 18 will be described further specifically.

First, when the picture signal is input, the histogram acquisition circuit 17 measures the number pf pixels for each luminance level to acquire the luminance histogram. At this moment, it is assumed that the level decomposition number is sufficiently finer for a dynamic range of an input signal (e.g., 256 division of 8-bit resolution).

After acquiring of one frame, the histogram information is input to the processor 18. The processor 18 calculates an LUT to be a high-frequency accentuation amount of each level and an LUT (γ characteristics) to be the high-frequency accentuation amount for the non-linear characteristics. It is assumed that the high-frequency accentuation amount and the level decomposition number of the non-linear processing characteristics are sufficiently fine for the dynamic range of the input signal (e.g., 256 division of 8-bit resolution).

Here, the high-frequency accentuation amount of the horizontal contour correction circuit 16 and the non-linear characteristics of the non-linear processing circuit 15 are given by independently calculated from the input histogram information.

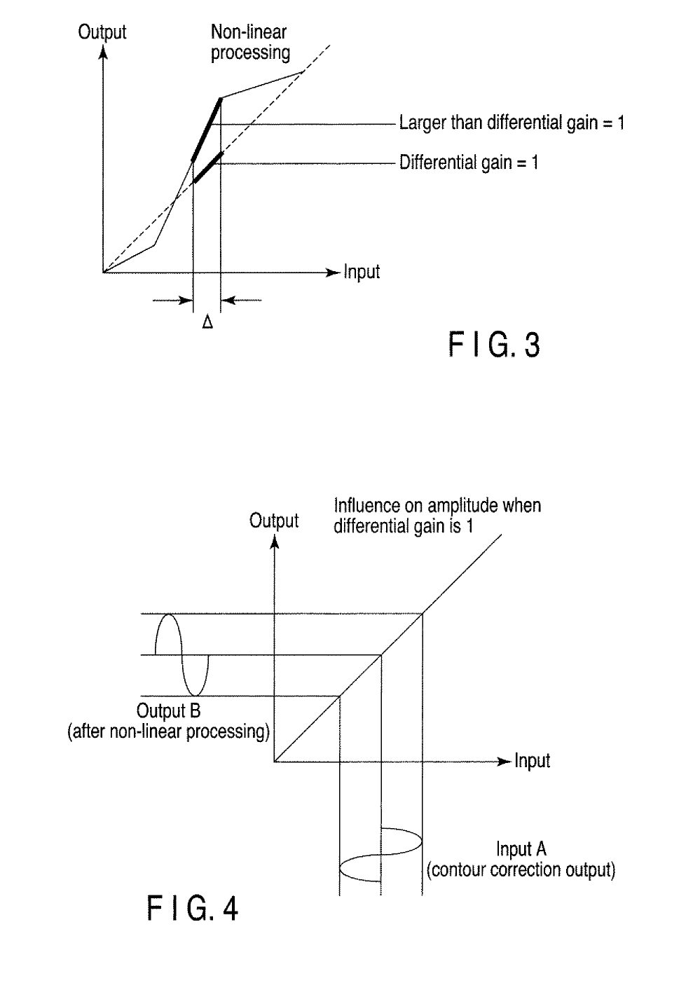

The influence of the non-linear characteristics will be described with reference to FIG. 3. In the non-linear characteristics of FIG. 3, a doted line indicates a case where the ratio between an input and an output is 1 to 1, and a full line indicates an actual use example. The differential gain at an input level Δ is equivalent 1 by the doted line, and is larger than 1 by the full line.

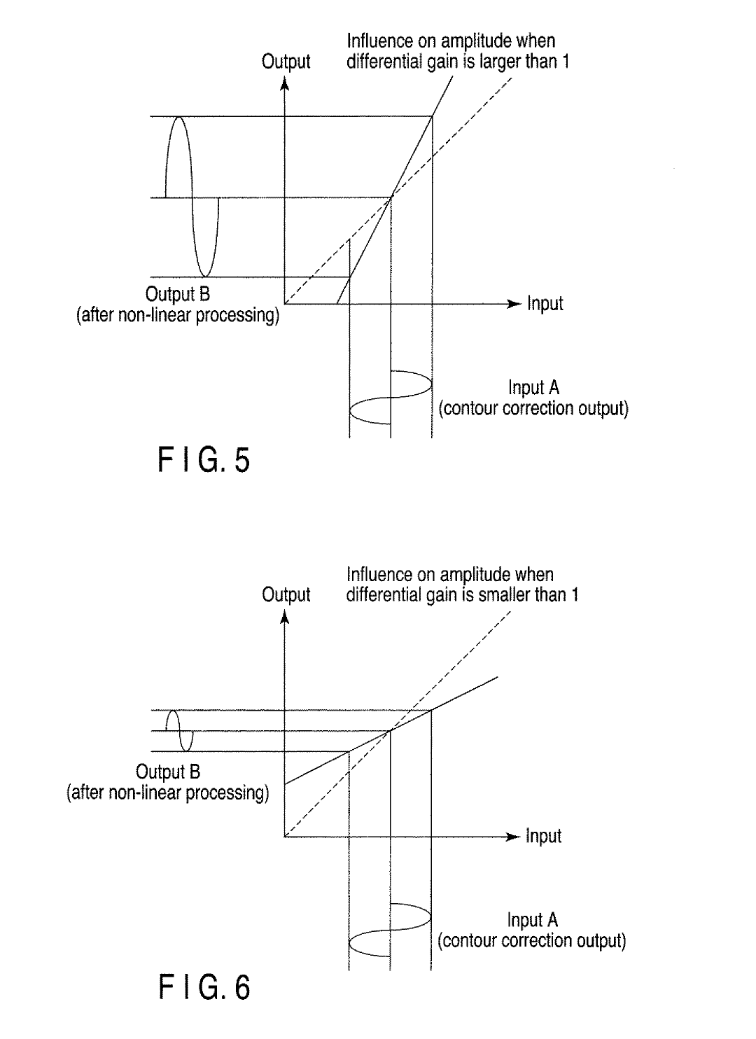

If the differential gain is equal to 1, the amplitude of the horizontal contour correction output is not affected by the non-linear characteristics as shown in FIG. 4. Conversely, if the differential gain is larger than 1, a positive output of the horizontal contour correction output is extended by the non-linear characteristics as shown in FIG. 5. If the differential gain is smaller than 1, the horizontal contour correction output is compressed by the non-linear characteristics as shown in FIG. 6. Here, each input A (contour correction output) in FIGS. 4 to 6 is the output from the multiplier 162 shown in FIG. 1.

In terms of a setting method of the high-frequency accentuation amount of the processor 18, if the control amount of the horizontal contour correction circuit 16 is set to Ga, the differential gain of the non-linear processing is set to Gb, and the desired high-frequency accentuation amount to the input signal is set to G, the control in this flowchart calculates the control amount Ga to each input level so that the following equation G=Ga×GB is satisfied.

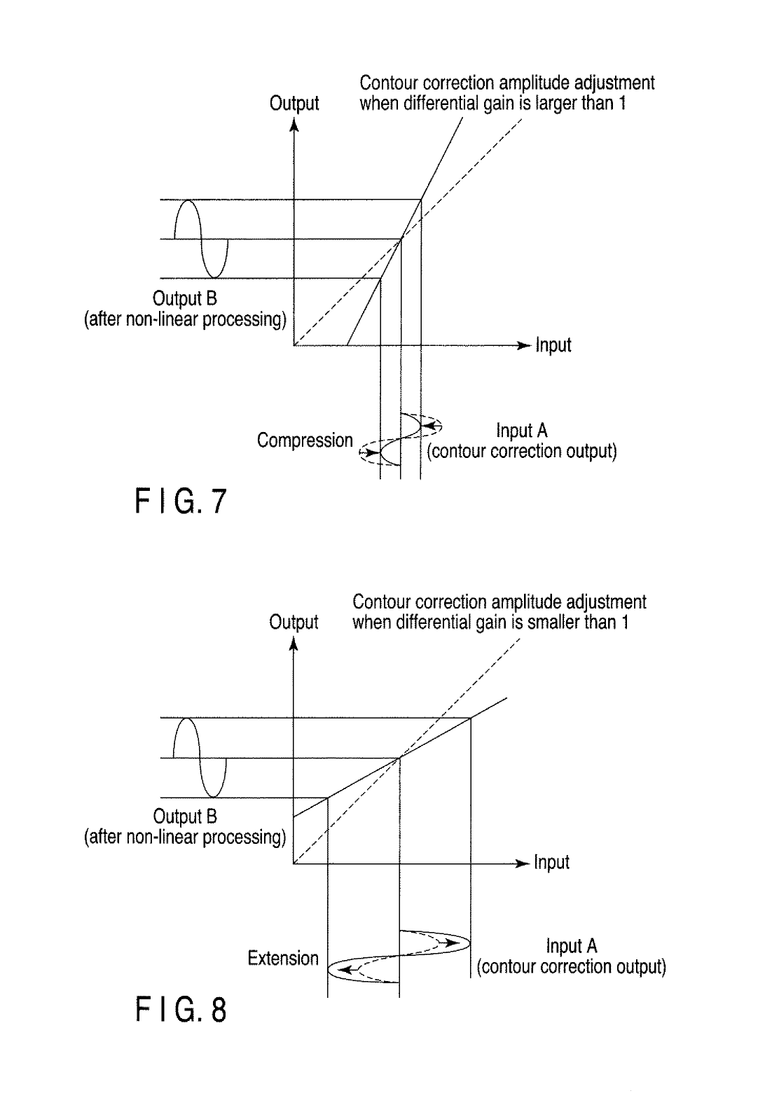

For instance, if the differential gain of the non-linear characteristics shown in FIG. 7 is larger than 1, the control compresses the amplitude of the contour correction output in order to obtain the same output B as that of in a case where the differential gain is equal to 1. If the differential gain of the non-linear characteristics shown in FIG. 7 is smaller than the differential gain 1 shown in FIG. 8, the control extents the amplitude of the contour correction output.

Thereby, it becomes possible to control the desired contour correction amount constant without being affected by the non-linear processing. Thus, it becomes possible to obtain the picture of which the contour correction is optimally performed without being affected by the non-linear processing.

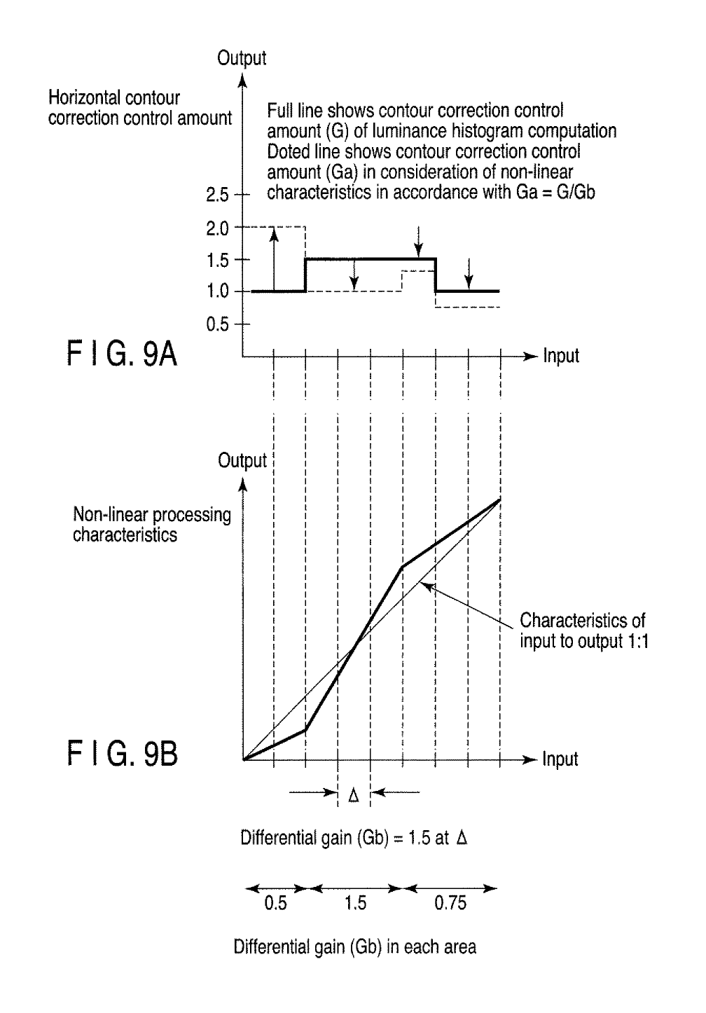

More specifically, the relationship between the horizontal contour correction control amount and the non-linear characteristics will be described with reference to FIGS. 9A and 9B.

FIG. 9A shows a characteristics example of the foregoing horizontal contour correction amount (output from the LUT storage module 163 of FIG. 1), a full line indicates the control amount (gain G) obtained through computation from the luminance histogram of the input signal, and a doted line indicates the control amount (gain Ga) in consideration of the non-linear characteristics. FIG. 9B shows a predetermined non-linear characteristics example, a thick full line indicates the non-linear processing characteristics example, and a thin full line indicates characteristics of 1 to 1 of the ratio between the input and the output.

In terms of a setting method of the control amount (gain Ga) of the horizontal contour correction circuit of the invention, the method firstly calculates the control amount (G) and the differential gain (Gb) at each level Δ through the horizontal contour correction control characteristics and the non-linear processing characteristics calculated from the luminance histogram of the input signal. Subtracting the gain (Gb) of the non-linear processing characteristics from the horizontal contour correction control amount for each level Δ enables calculating an optimum contour correction control amount (Ga) in consideration of the influence of the non-linear processing.

As mentioned above, in the foregoing embodiment, even if the horizontal contour correction is used together with the non-linear processing in the picture signal processing, it is possible to decide the contour correction control amount in consideration of the non-linear processing characteristics, and achieve final and optimum contour correction.

While the foregoing embodiment has been described in the case where the non-linear processing circuit is disposed on a latter stage of the horizontal contour correction circuit, even if the order thereof becomes reversed, since the alternating current gain of the level Δ in the non-linear contour processing affects the horizontal contour correction circuit, it is necessary to control so as to make the gain value at the final output constant. That is, since the correction component of the horizontal contour correction is an alternating current component, and the non-linear processing becomes directing current conversion characteristics, although the alternating current gain seems not to affect the horizontal contour correction circuit on first viewing; however, the correction component affects the alternating current for the point of the level Δ. Thus, even when the horizontal contour correction circuit is disposed on the later stage of the non-linear processing circuit, the invention can have the same effect as that of the foregoing embodiment.

Although the non-linear processing (RGB γ) for panel control (white balance adjustment) of the display 19 is preferable to be disposed immediately in front of the panel, since the non-linear processing of this time becomes Y γ correction, etc., it is not always necessary to dispose the non-linear processing (RGB γ) immediately in front of the panel. Therefore, in the invention, it is possible to accurately perform the horizontal contour correction with having no relation to the position of the non-linear processing.

Other than this, the invention is not limited to the embodiments shown and described herein, and in an implementation phase, this invention may be embodied in various forms without departing from the spirit or scope of the general inventive concept thereof. Various types of the embodiments can be formed by appropriately combining a plurality of constituent elements as far as possible, and in such a case, the effect of the combination can produce satisfactory results. Further, inventions on various stages are included in the foregoing embodiments; various types of the invention can be extracted by means of appropriate combinations of a disclosed plurality of constituent elements. Even if, some of elements, for example, are omitted from all the constituent elements shown in the elements mentioned above, in a case where the problems described in the column of “Problem to be Solved by the Invention” can be solved, and in a case where the effects described in the column of “Effect of the Invention” can be obtained, the configuration from which the constituent elements are omitted can be extracted as the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A picture processing device which uses a horizontal contour correction processing together with non-linear processing, comprising:
a horizontal contour correction module configured to extract a high-frequency component of a picture signal, generate a contour correction signal by selectively multiplying the high-frequency component by an arbitrary accentuation amount, and correct a horizontal contour of a picture by adding the contour correction signal to the picture signal;
a histogram acquisition module configured to measure the number of pixels of each luminance level of the picture signal to acquire a luminance histogram; and
a computation control module configured to compute a control amount instructing the accentuation amount on the basis of the luminance histogram, wherein
the computation control module acquires a first control amount for each luminance level of the horizontal contour correction processing from the luminance histogram, acquires a second control amount for each luminance level of the non-linear processing from the luminance histogram, and acquires a third control amount which can acquire the first control amount when the second control amount is given to supply the third control amount to the horizontal contour correction module.

2. The device of claim 1, wherein
the computation control module calculates a control amount G, as the first control amount, for each luminance level of the horizontal contour correction processing from the luminance histogram; calculates a differential gain Gb, as the second control amount, for each luminance level of the non-linear processing from the luminance histogram; calculate a control amount Ga of a horizontal contour correction in consideration of characteristics of the non-linear processing for each luminance level in accordance with a relationship formula of G=Ga×Gb, and then acquires the third control amount.

3. A picture processing method for use in a picture processing device in which a horizontal contour correction processing is used together with non-linear processing, comprising:
extracting a high-frequency component of a picture signal;
generating a contour correction signal by selectively multiplying the high-frequency component by an arbitrary accentuation amount;
correcting a horizontal contour of a picture by adding the contour correction signal to the picture signal;
measuring the number of pixels of each luminance level of the picture signal to acquire a luminance histogram; and
computing a control amount instructing the accentuation amount on the basis of the luminance spectrum; and the method further comprising:
acquiring a first control amount for each level of the horizontal contour correction from the luminance histogram, acquiring a second control amount for each luminance level of the non-linear processing from the luminance histogram; and
acquiring a third control amount which can acquire the first control amount when the second control amount is given to make the third control amount be a control amount of the horizontal contour correction.

4. The device of claim 3, where the computing of the control amount instructing the accentuation amount calculates a control amount G, as the first control amount, for each luminance level of the horizontal contour correction processing from the luminance histogram; calculates a differential gain Gb, as a second control amount, for each level of the non-linear processing from the luminance histogram; and acquires the third control amount for each luminance level by calculating a control amount Ga of a horizontal contour correction in consideration of characteristics of the non-linear processing in accordance with a relationship of G=Ga×Gb.

5. A picture display device which applies horizontal contour correction processing and non-linear processing to an input picture signal to display the picture signal, comprising:
a horizontal contour correction module configured to extract a high-frequency component of a picture signal, generate a contour correction signal by selectively multiplying the high-frequency component by an arbitrary accentuation amount, and correct a horizontal contour of a picture by adding the contour correction signal to the picture signal; a histogram acquisition module configured to measure the number of pixels of each luminance level of the picture signal to acquire a luminance histogram; a computation control module configured to compute a control amount instructing the accentuation amount on the basis of the luminance histogram; and a display module configured to display the picture signal with the horizontal contour correction processing performed thereto, wherein
the computation control module acquires a first control amount for each luminance level of the horizontal contour correction processing from the luminance histogram, acquires a second control amount for each luminance level of the non-linear processing from the luminance histogram; and acquires a third control amount which can acquire the first control amount when the second control amount is given to supply the third control amount to the horizontal contour correction module.

6. The device of claim 5, wherein
the computation control module calculates a control amount G, as the first control amount, for each luminance level of the horizontal contour correction processing from the luminance histogram; calculates a differential gain Gb, as the second control amount, for each level of the non-linear processing from the luminance histogram; and acquires the third control amount by calculating for each luminance level a control amount Ga of a horizontal contour correction in consideration of characteristics of the non-linear processing in accordance with a relationship of G=Ga×Gb.
